(19) United States
(12) Patent Application Publication
(10) Pub. No.: US 2014/0110270 A1
(43) Pub. Date: Apr. 24, 2014

(54) ELECTRICAL ANODE REDUCTION OF SOLID OXIDE FUEL CELL

(71) Applicant: Topsøe Fuel Cell A/S, Kgs. Lyngby (DK)

(72) Inventors: Thomas Heiredal-Clausen, Copenhagen (DK); Kresten Juel Nikolaj Laut Jensen, Hellerup (DK)

(73) Assignee: Topsøe Fuel Cell A/S, Kgs. Lyngby (DK)

(21) Appl. No.: 14/119,481

(22) PCT Filed: May 26, 2011
(86) PCT No.: PCT/EP2011/002603

§ 371 Date: Nov. 22, 2013

(51) Int. Cl. H01M 4/88

(52) U.S. Cl. CPC H01M 4/88
USPC 205/594

(57) ABSTRACT

A solid oxide fuel cell is anode reduced without the use of a reducing gas by applying a voltage to the cell when the temperature is elevated to a target temperature.

The present invention relates to an improved method for reducing the anode of fuel cells, in particular solid oxide fuel cells. The improved method particularly relates to electrical anode reduction of solid oxide fuel cells without the application of a reducing purge gas, i.e. in an ambient air environment. Furthermore, the present invention relates to solid oxide fuel cell stacks.

A fuel cell is an energy-converting device that electrochemically reacts a fuel with an oxidant to generate a direct current. A fuel cell is comprises a cathode, an electrolyte and an anode, wherein an oxidation agent, for example air, is fed to the cathode, and the fuel, for example hydrogen, is fed to the anode. The electrolyte separates the oxidant and the fuels and allows ionic transport of the reactant.

In a typical concept of a solid oxide fuel cell, oxygen ions form on the cathode in the presence of an oxidizing agent such as air. The oxygen ions diffuse through the electrolyte and recombine on the anode side, creating water with the hydrogen that comes from the fuel. As this recombination occurs, electrons are released and thus electrical energy is generated.

In order to achieve a high electric output, several fuel cells are electrically and mechanically connected to each other by means of interconnecting components, i.e. interconnectors. Using the interconnectors, the fuel cells can be stacked on top of each other and be electrically connected in series in order to provide a so-called fuel cell stack. These basic components of a stack, namely the cathode, the electrolyte the anode and the interconnectors, must be assembled such that they remain together with good electrical contact at all times in order to reduce ohmic losses. Additionally, gaskets/seals can be positioned between the layers to prevent undesirable leakage of gases used by the fuel cells.

The main feature that distinguishes solid oxide fuel cells (SOFC) from other types of fuel cells is their all solid design and their high operating temperature. Due to this high operating temperature, in combination with the commonly-used ceramic material of the SOFC, the matching of the material as well as the bonding to different stack elements is critical, as thermal stresses can be generated upon changing the temperature from ambient to operating temperature.

Currently, two basic stack constructions are used for SOFCs, i.e. planar cell stacks and tubular cell stacks/bundles. In both designs, the mechanical integrity of the stack and electrical contact between the fuel cells and the interconnect subassemblies typically occurs through direct mechanical compression. In order to enhance the contact between the electrodes and the interconnects, it is known to use sealing materials such as high-temperature glasses and cements, in order to glue the materials together.

The anode of the solid oxide fuel cell may contain nickel or other metals which are present in their oxide state when the fuel cell is produced. Prior to operation of the fuel cell it is necessary to reduce the metal oxide such as nickel oxide to its metal state, for the fuel cell or the fuel cell stack to operate effectively. During the reduction treatment, the nickel oxide is reduced to nickel, In other words, at least a portion of the nickel in the anode electrode is in a form of nickel oxide, and at least a portion of the nickel oxide is reduced to nickel during the reduction treatment.

In prior art such as US 2006/0222929 A1 it is disclosed to electrochemically reduce the anode side of a solid oxide fuel cell by applying an external voltage to each fuel cell in a stack in a reverse current direction while a gas such as nitrogen, hydrogen or argon is provided to the fuel cell anode side and an oxygen containing gas such as air is provided on the fuel cell cathode side. During the reduction process the fuel cell may be operated at its normal designed operating temperature, such as 800° C. to 900° C.

Also JP 2008034305 discloses an anode reduction method of a solid oxide fuel cell. A purge gas is sent to the fuel passage side of the anode of the solid oxide fuel cell, a reverse current is sent to the solid oxide fuel cell while sending an oxidizer gas to the oxidizer passage side of a cathode, and thereby the oxide of a catalyst metal in the anode is electrochemically reduced.

Though the known art methods of anode reduction of a solid oxide fuel cell may be effective, they are cumbersome, expensive and environmental harmful. The application of two different gasses to the cathode side and the anode side of the fuel cell respectively requires the mounting of gas manifolds while reducing the anode. The necessary reducing gasses are expensive and further need to be removed from the process with thereby following environmental consequences. Also the process needs to be handled with care and safety guidelines followed as the gasses are flammable.

It is the object of the present invention to provide a new method for reducing the anode of a solid oxide fuel cell which overcomes at least some of the problems related to known art solid oxide fuel cell anode reduction.

It is a further object of the present invention to provide an electrical anode reduction of a solid oxide fuel cell in an ambient air environment, i.e. without the use of a reducing purge gas.

It is a further particular object of the present invention to provide an electrical anode reduction of a solid oxide fuel cell stack which can be performed to the stack while it is undergoing the combined heat- and pressure treatment to ensure sealing and contacting between the layers of the stack (the “birth”) after the assembly of the stack components.

It is yet a further object of the present invention to provide a solid oxide fuel cell system which is anode reduced in a less cumbersome, efficient, economic and more environmental friendly process as compared to known art.

In this respect, the present invention relates to a method for electrical anode reduction of at least one solid oxide fuel cell comprising at least an anode, a cathode and an interposed electrolyte and an interconnector assembled to form an assembled solid oxide fuel cell.

Contrary to the known art, the electrical anode reduction takes place without the presence of a reducing gas on the anode side of the fuel cell. In known art it is described that the presence of a reducing gas is necessary to reduce the anode because of the reduction kinetics of the metal oxides, for instance NiO. With rising temperature the oxidation speed of nickel increases, therefore it is a prejudice that reducing a nickel containing anode at high temperature requires the presence of a reducing gas. But according to the present invention it has been discovered that an electrical reduction of the anode is possible in an ambient air environment.

According to the method, at least one solid oxide fuel cell is provided in an ambient air environment. Often several cells are stacked to form a solid oxide fuel cell stack, the anode reduction method applies to stacks as well. The temperature is raised from ambient temperature to a target temperature above 700° C., sufficient to reduce the anode. The exact target temperature can be chosen to suit the given process characteristics. The limits for the temperature is determined by the maximum acceptable anode reduction reaction time, which defines the lower limit for the target temperature and the maximum allowable temperature above which the components of the solid oxide fuel cell will be destroyed. As an advantage for the production costs, the anode reduction can take place while the solid oxide fuel cell stack is heat- and pressure treated during the stack “birth”.

During the heat treatment, a voltage is applied to each fuel cell in the stack. The voltage is in the range of 0.6 to 2.4 Volt pr. cell. Here the limits of the range is determined as a lower limit under which the anode reduction is not taking place and a higher limit above which the electrolyte will be destroyed. Again, the exact voltage pr. cell is chosen to suit the process characteristics of the solid oxide fuel cell stack to be anode reduced. Often the voltage will be in the range of 0.69 to 2.0 Volts per cell.

While the heat treatment and voltage application of the anode reduction process is taking place, the current through the fuel cell(s) is monitored. After a period of time, the current will sink to a stable low level. This is an indication that substantially all the metal oxide of the anode has been reduced. The heat treatment and applied voltage to the fuel cell or fuel cell stack is continued at least until the stable low current level is observed.

According to the present invention, it has been discovered that the electrical anode reduction is taking place without the presence of a reducing gas even though the anode is covered with an electrically insulating metal oxide layer such as nickel oxide.

In an embodiment of the invention, the target temperature is in the range of 800° C. to 1100° C., preferably in the range of 875° C. to 925°. In a further embodiment of the invention, the heat treatment of the solid oxide fuel cell(s) at the target temperature is maintained for 15 to 720 minutes, preferably 120 to 600 minutes.

According to a further embodiment, the compression pressure applied to the solid oxide fuel cell stack during the “birth” where the anode reduction according to the invention is performed can be in a range of 0.8 to 1.2 MPa. It has been shown that a respective pressure is sufficient in order to provide a very close contact between the surfaces, i.e. to provide good mechanical contact.

In a further embodiment of the invention, the fuel cell or fuel cell stack is heated with a temperature ramp of 300 to 315 K/h from ambient temperature to the target temperature, for example 800° C. to 1100° C. By providing a rapid heating treatment, unnecessary corrosion of the interconnector, i.e. the ferritic stainless steel material, can be avoided.

The method of the invention can furthermore comprise the step of cooling the fuel cell or fuel cell stack to ambient temperature, for example with a temperature ramp of 180 to 220 K/h. A respective temperature provides a method which can be performed within a short time period, i.e. the overall costs can be kept as low as possible.

The method can be performed using a hot press.

Furthermore, the present invention provides a solid oxide fuel cell system comprising at least one assembled solid oxide fuel cell comprising at least an anode, a cathode and an interposed electrolyte and an interconnector, wherein the anode is electrically reduced in an ambient air environment, i.e. without the application of a reducing gas to the anode side of the fuel cell. The solid oxide fuel cell system is electrically reduced by heat treatment of the at least one solid oxide fuel cell at a target temperature above 700° C. and with the application of a voltage in the range of 0.6 to 2.4 Volt pr. cell until the electrical current through the at least one solid oxide fuel cell has reached a constant low level, which indicates that substantially all the metal oxides has been reduced to metal and oxygen, i.e. the anode reduction is completed.

The solid oxide fuel cell system may comprise a plurality of fuel cells which are assembled to form a solid oxide fuel cell stack. As the anode reduction of the solid oxide fuel cell system can be performed during the stack “birth” and without the presence of a reducing gas, the anode reduced solid oxide fuel cell system of the present invention is produced more efficient, cost reduced and environmental friendly than solid oxide fuel cell systems produced according to known art methods.

In an embodiment of the invention the material of the anode is NiO/ZrO₂ ceramic metal composites, i.e. cermet, a material which is known for its properties as anode of a solid oxide fuel cell.

In a further embodiment the material of the anode support, if necessary, is NiO/YSZ. This material has proven its applicability for the respective function, as it provided sufficient strength to the cell.

Further, the material of the electrolyte can be YSZ and/or Sc—YSZ. Again, this material has proven to be a preferred electrolyte material in the state of the art.

In an embodiment the material of the interconnect is CroferAPU 22, a material which is commercially available from Thyssen Krupp. This material has been specifically developed as a material for the interconnector plate of high-temperature fuel cells.

According to a further embodiment, it is preferred that the interconnect is provided with a structured surface, i.e. a grooved surface, corrugated surface or an egg tray surface. It should be understood that the named surfaces are only examples; a person skilled in the art will know that further designs of the surface are also possible. A respective structured surface enables the metallic structure to be compressed under pressure and high temperature in order to provide a good mechanical contact between the interconnect and the ceramic fuel cell.
1. Method for electrical anode reduction of at least one solid oxide fuel cell comprising at least an anode, a cathode, an interposed electrolyte and an interconnector, assembled to form an assembled solid oxide fuel cell, comprising the steps of:
   providing the at least one solid oxide fuel cell in an ambient air environment
   raising the temperature of the at least one solid oxide fuel cell from ambient temperature to a target temperature above 700° C., sufficient to reduce the anode
   applying a voltage in the range of 0.6 to 2.4 Volt pr. cell to the at least one solid oxide fuel cell, sufficient to reduce the anode
   cooling the at least one solid oxide fuel cell to ambient temperature when the electrical current through the at least one solid oxide fuel cell has reached a constant low level, whereby the anode reduction is completed,
   cutting off the voltage to the at least one solid oxide fuel cell.
2. Method according to feature 1, characterized in that the at least one solid oxide fuel cell is a plurality of solid oxide fuel cells stacked to form a solid oxide fuel cell stack.
3. Method according to feature 2, characterized in that a sufficient pressure for the solid oxide fuel cell components to achieve mechanical contact is applied during the anode reduction.
4. Method according to any of the preceding features, characterized in that the target temperature is in the range of 800° C. to 1100° C.
5. Method according to any of the preceding features, characterized in that the target temperature is maintained for 15 to 720 minutes, preferably 60 to 600 minutes.
6. Solid oxide fuel cell system comprising at least one assembled solid oxide fuel cell comprising at least an anode, a cathode and an interposed electrolyte and an interconnector, characterized in that the anode is electrically reduced by heat treatment of the at least one solid oxide fuel cell at a target temperature above 700° C. and applying a voltage in the range of 0.6 to 2.4 Volt pr. cell to the at least one solid oxide fuel cell in an ambient air environment until the electrical current through the at least one solid oxide fuel cell has reached a constant low level, whereby the anode reduction is completed.
7. Solid oxide fuel cell system according to feature 6, characterized in that the at least one solid oxide fuel cell is a plurality of solid oxide fuel cells assembled to form a solid oxide fuel cell stack.
8. Solid oxide fuel cell system according to feature 6 or 7, characterized in that the material of the anode is a NiO/ZrO₂ ceramic metal composite and/or the material of the anode support, if present, is NiO/YSZ and/or the material of the electrolyte is YSZ and/or Sc—YSZ.
9. Solid oxide fuel cell system according to any one of features 6-8, characterized in that the material of the interconnect is Crofer APU 22
10. Solid oxide fuel cell system according to any one of features 6-9, characterized in that the interconnect is provided with a structured surface, i.e. a grooved surface, corrugated surface or an egg tray.

A preferred embodiment of the present invention is described below with reference to the attached drawings.

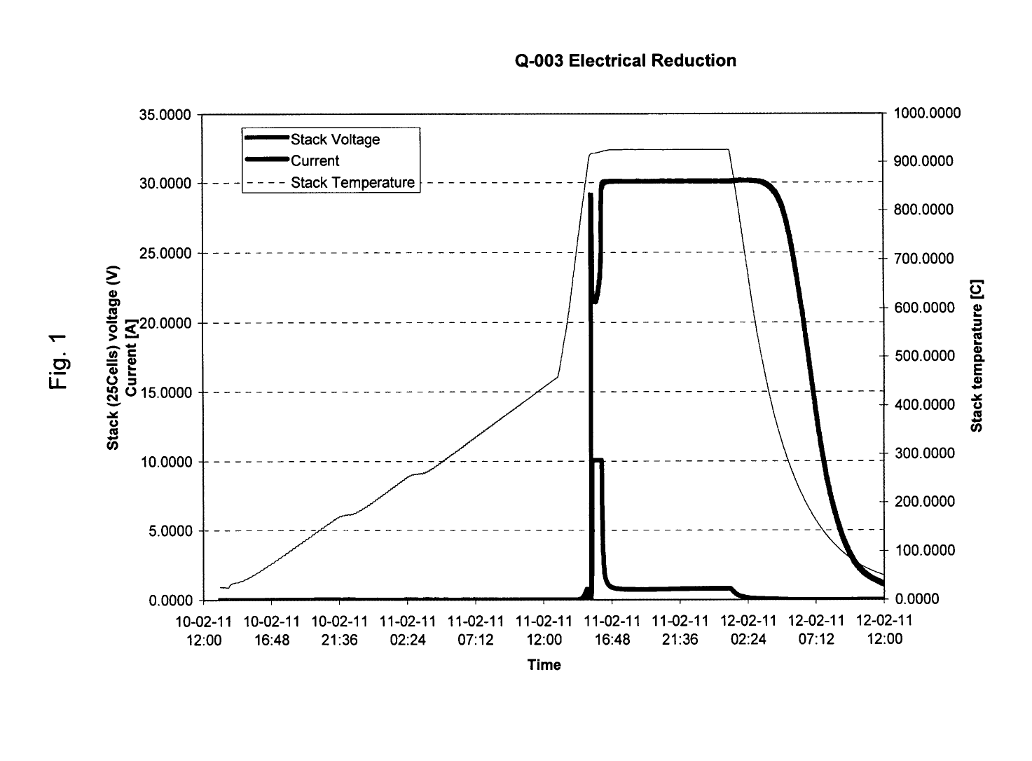

FIG. 1 is a graph which illustrates the relationship between voltage, current and temperature over time of an SOFC during electrical anode reduction according to the present invention.

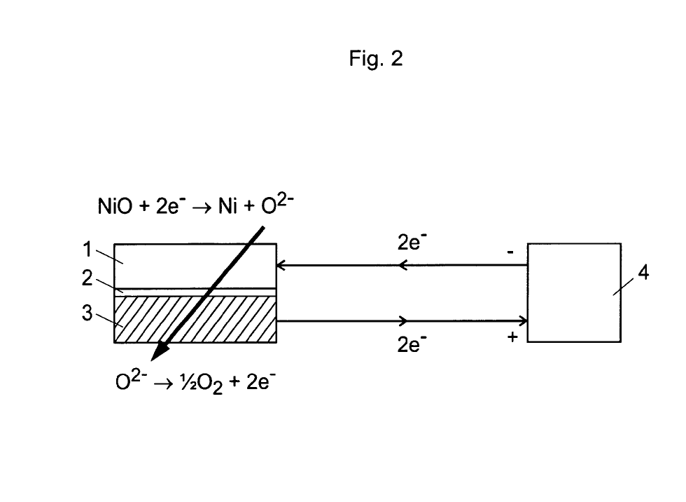

FIG. 2 illustrates the electro-chemistry of the anode reduction of a solid oxide fuel cell according to the invention.

The invention will be more fully-understood and further advantages will become apparent when reference is made to the following detailed description of embodiments of the invention according to the figures.

In FIG. 1 a graph shows the relation between voltage, current, temperature and time for an anode reduction of a solid oxide fuel cell stack according to an embodiment of the invention. A solid oxide fuel cell stack comprising 25 assembled solid oxide fuel cells is placed in a hot press in an ambient air environment. The stack is heated to app. 900° C. by increasing the furnace temperature. The temperature curve is the thin line shown in FIG. 1. As seen, the temperature starts at room temperature of app. 25° C. at ca. 13:00 hours. While the temperature is slowly rising to app. 450° C. during about 12 hours and then more quickly rises to app. 900° during further about 2 hours, there is no significant current measured, since no voltage is applied to the fuel cells and no reactive gas (fuel) is present. The current is illustrated by the fat line and the voltage is illustrated by the fat, bold line.

When the stack is heated to app. 900° C. a voltage of 30 Volt is applied to the stack i.e. 1.2 Volt pr. fuel cell. This is illustrated by the fat line. As can be seen, the current through the fuel cells after a while rises to 10 Amps when the voltage is applied. The time delay before the current rises is due to the fact that initially only a low current can run through the to some extent electrically insulating nickel oxide layer. But after a short time, the anode reduction creates better electrical contact and the process runs fast and the current remains at 10 Amps for about an hour. The shown local drop in voltage is due to the current limitation set on the power supply source. After about an hour of electrical anode reduction, the current drops to app. 1 Amps, while the voltage applied to the cells remains constant. This stable low current is an indication that substantially all the nickel oxide has been reduced to metal nickel and oxygen. Hence, at this point the anode reduction process could actually be stopped. The reason why the heat and voltage is kept applied is that the “birth” process of the stack is taking place concurrent with the electrical anode reduction. After the completion of the anode reduction as well as the stack “birth”, the stack is again cooled down to ambient temperature. To protect the anode, to prevent it from oxidizing again, the voltage is remained applied to the cells until the temperature has dropped below a critical level. Whatever oxygen that comes into contact with the anode during this period, diffuses through the electrolyte because of the applied voltage, this is the reason for the app. 1 Amps current measured. The current further drops to a stable low level near zero when the temperature drops below a critical value.

The described anode reduction is performed in an ambient air environment, without any use of reducing purge gas for the anode reduction.

In production of solid oxide fuel cell stacks, it is as mentioned necessary to pressure- and heat treat the assembled stack to ensure a good mechanical and electrical contact of the stack components, and to seal the stack at the seal surfaces. This stack “birth” can advantageously take place simultaneously as the described anode reduction, thereby saving production costs and time.

FIG. 2 illustrates the electro-chemical reduction process taking place when anode reducing a solid oxide fuel cell according to the present invention. A solid oxide fuel cell is shown, comprising an anode 1, a cathode 3, and an interposed electrolyte 2, assembled to form a solid oxide fuel cell. Several cells can as described be stacked (not shown) with interconnects in-between to form a whole fuel cell stack; however for the explanation of the reduction principle only one cell as shown is necessary. A voltage is applied to the solid oxide fuel cell by means of any suitable electrical power source 4. The negative terminal of the power source is connected to the anode side of the solid oxide fuel cell and the positive terminal of the power source is connected to the cathode side. Electrons are transferred to the anode, and because of the raised temperature, the kinetics allow for the Ni—O bonds to rupture, producing metallic nickel and oxygen ions. The oxygen ions diffuse to the cathode side of the fuel cell where free oxygen is released and electrons are transferred back to the power source. When substantially all nickel oxide is reduced to metallic nickel and oxygen ions, the described process can no longer proceed. No electrons are therefore transferred as a consequence of nickeloxide reduction, and the output current drops to a stable low level indicating the completion of the anode reduction.

### Example

The solid oxide fuel cells as used in the experiments are fuel cells known to a person skilled in the art, i.e. commonly used in the field. In particular, the anode and cathode are interposed by an electrolyte, specifically by a YSZ or Sc—YSZ electrolyte. The material used for the cathodes is known in the art and hence will not be described in detail. The most common material is strontium doped lanthanum manganite, however, a doped Ia-based perovskite has also been suggested and is used as a material for cathodes. As an anode material, an NiO ZrO₂ material is used. These materials are now the most commonly used for anodes.

In order to provide an SOFC fuel cell stack, a plurality of single cells is used, wherein an interconnect is interposed between every two cells in order to separate same from each other. The interconnect has to provide electrical contact between the single cells and has to separate the fuel and air sides and distribute the gases to the cells. Consequently, the interconnect can be provided with a structured surface, for example, a corrugated surface or an egg tray surface in order to provide a good gas transportation.

A solid oxide fuel cell stack comprising 25 solid oxide fuel cells is positioned in a hot press for stack “birth” in an ambient air environment. After heat treatment and anode reduction as described above, the Area Specific Resistance (ASR) of the stack which is anode reduced according to the present invention was compared to the ASR of a similar stack reduced with H2 as reducing gas as known in the art.

### Results:

### Electrical Anode Reduced Solid Oxide Fuel Cell Stack:

Cell voltage at 750° C. and 25 Amps=870 mV/Cell

### H2 Anode Reduced Solid Oxide Fuel Cell Stack (Known Art):

Cell voltage at 750° C. and 25 Amps=860 mV/Cell.

1. Method for electrical anode reduction of at least one solid oxide fuel cell comprising at least an anode, a cathode, an interposed electrolyte and an interconnector, assembled to form an assembled solid oxide fuel cell, comprising the steps of:
providing the at least one solid oxide fuel cell in an ambient air environment,
raising the temperature of the at least one solid oxide fuel cell from ambient temperature to a target temperature above 700° C., sufficient to reduce the anode,
applying a voltage in the range of 0.6 to 2.4 Volt per cell to the at least one solid oxide fuel cell, sufficient to reduce the anode,
cooling the at least one solid oxide fuel cell to ambient temperature when the electrical current through the at least one solid oxide fuel cell has reached a constant low level, whereby the anode reduction is completed,
cutting off the voltage to the at least one solid oxide fuel cell.

2. Method according to claim 1, characterized in that the at least one solid oxide fuel cell is a plurality of solid oxide fuel cells stacked to form a solid oxide fuel cell stack.

3. Method according to claim 2, characterized in that a sufficient pressure for the solid oxide fuel cell components to achieve mechanical contact is applied during the anode reduction.

4. Method according to claim 1, characterized in that the target temperature is in the range of 800° C. to 1,100° C.

5. Method according to claim 1, characterized in that the target temperature is maintained for 15 to 720 minutes, preferably 60 to 600 minutes.

6-10. (canceled)
